(19) United States
(12) Patent Application Publication
(10) Pub. No.: US 2007/0294894 A1
(43) Pub. Date: Dec. 27, 2007

(54) Food corer

(76) Inventors: Pamela Kay Hershey, SantaCruz, CA (US); William Earl Hershey, (US)

Correspondence Address: Walt Froloff, 273D Searidge Rd, Aptos, CA, 95003, US

(21) Appl. No.: 11/823,319

(22) Filed: Jun. 27, 2007

Related U.S. Application Data
(60) Provisional application No. 60/816,737, filed on Jun. 27, 2006.

(51) Int. Cl. A47J 23/00

(52) U.S. Cl. 30/113.1

(57) ABSTRACT

The present invention discloses a one piece food corer with a hook design providing an efficient and elegant tool for coring food. The basic design is without attachments or other accoutrements. The user of the corer is able to use one tool for a specific purpose, hollowing out the flesh from a vegetable or fruit.

### BACKGROUND

1. Field of the Invention

The present invention relates generally to a kitchen tool for food core extraction, and particularly for hollowing out the inside of vegetables and/or fruits and other foods, leaving a cavity or a hole as desired.

The general area of kitchen tool corers is not new. Hollowing out a zucchini can be challenging, and very unsuccessful. One apple corer having four molded plastic components are fitted together. They are a hollow cutting tube, a core remover slidable along the cutting tube, a handle attached at the end of the cutting tube, and a compression plug inserted at the same end for locking the handle in place. The tip of the cutting tube has serrated teeth for smooth boring into the apple. In operation, the handle is oscillated while applying pressure to it. This causes the cutting tube to bore through the apple.

While popular, the hollow cutting tube variety wastes material, since corers do not actually need a full tube. Moreover, the “compression plug” for locking the handle in place and the additional parts make this type of corer wasteful and complicated. Further oscillation of the handle makes this an awkward and unnecessarily hard way to extract the meat.

Some corers can better be categorized as melon-ballers, melon-cutters, and zucchini corers where they are used primarily to create a decorative effect rather than to solve a basic food preparation problem.

Other corers have a coring assembly comprising a continuous ring of thin stainless steel circle or ring. The ring is joined to, or is an extension of, a thin zig-zag band portion which is joined to the handle. While an improvement, this type still lacks ease of use, tearing the core out of the fruit or vegetable instead of an easy insert and slice removal. Still most corers use a non-elegant once through method of leaving the object with a through hole, thus making it difficult to contain ingredients and forcing the food prepared to look less appealing.

Another corer comprises a cylindrically shaped or tubular body with an axially-slidable side member that alternately ejects and retracts a core-slicing or cutting structure removable of a portion of the core of a fruit, and provided with another axially-slidable ejector member. This type of corer is good for straight through boring and is a slight improvement on the tubular boring corer. However, most designs still suffers from the heavy wasteful inelegant tubular body and complications in the practical application of extraction of the core with the axially-slidable side members. The corers which are not totally tubular, are straight through corers, leaving a hole and not a cavity. The designs which leave a cavity leave an incomplete core which must be ripped out forcibly. Other types of corers do not allow that corer to be inserted smoothly and then attaching to the flesh to remove the body of a zucchini or other base for fill with other ingredients. Another type is a one piece tool for boring through an apple but not removing the core for filling, only a straight through core removal leaving a hole.

At times, food preparation requires the creation of an internal cavity for inserting ingredients for creative and ethnic dishes. Current corers punch a hole through the food item on both ends, not allowing inset ingredients, therefore losing all the precious healthy succulence in food dishes. A food item that can be filled with additional ingredients to make a healthy and delicious dish. A family favorite is stuffed zucchini, where the extraction of the body of the zucchini and insertion of several various ingredient options are required, followed by a slow cook for several hours. What are needed are coring feature which allow removal of seeds from vegetables such as cucumbers, which in some cases are required or needed for health requirements. Many corers on the market, allow “punching” a core out, but what is sometimes needed is a cavity for placement of other ingredients, without additional work or effert.

There is still need for a kitchen tool that can penetrate through the flesh and remove the body from a vegetable efficiently with a comfortably. Some settle for a tool difficult to assemble, use, disassemble and to clean, while other use a combination of multiple tools. For instance, in the past, a corer and a potato peeler would give you a good result. The flesh can be eaten, thrown away or used in a recipe. The precision of the tool would make the task much more efficient and a lot simpler. What is needed is an extracting corer, a one piece, no assembling or disassembling, possibly adjustable and without any attachments. What is needed is an easy to use, fast and simple to clean, without assembling/disassembling and still just hollowing out a a given fruit or vegetable. What is needed is a clean corer, cutting and attaching to the flesh in order to remove the body in the center for use in preparing food for filling

### SUMMARY

The present invention discloses a system for single piece device for coring fruits and vegetables and food comprising a handle, thin flat stem coupling an annular cutting ring to the handle, a serrated cutting edge on the distal end of the annular cutting ring, and a flattened curved hook element coupled to the opposite end of the annular cutting ring, hook tip extending substantially toward the cent of the ring axis. The annular cutting ring jagged cutting edge is inserted in the food object to be cored, to the depth desired and the axially rotated allowing the curved hook to circumscribe the inside food object end freeing the food core for hollowing.

An aspect of the single piece device provides for extracting the inside meat without a full penetration for insertion of alternate food ingredients.

### BRIEF DESCRIPTION OF DRAWINGS

Specific embodiments of the invention will be described in detail with reference to the following figures.

FIG. 1a is a side view of the extracting corer in accordance with an embodiment of the invention.

FIG. 1b is a top view of the extracting corer in accordance with an embodiment of the invention.

FIG. 2a is an enlarged side view of the extracting corer detailing the serrated edge and the core extract hook in accordance with an embodiment of the invention

FIG. 2b is an enlarged front view from the distil end of the extracting corer in accordance with an embodiment of the invention

FIG. 3 is a perspective view an extracting corer in accordance with an embodiment of the invention

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Objects and Advantages

There are several objects or advantages of the present invention. First, it can come in one piece tool for efficiency and ease to perform a task.

This corer is simpler for hollowing out the flesh from inside of the zucchini than any other tool invented. An aspect of the invention design has a curved triangular core extraction hook that enables the inside to be pulled out of the food object after the core flesh has been completely severed, core removal without ripping flesh. This makes it easier to remove the flesh without damaging other portions and consistency with just one tool. For example, one would be able to core many zucchini in a short period of time. Allowing the zucchini to be hollowed without breaking the skin or leaving too much of the flesh inside which makes it hard to fill for your recipes. Further objects and advantages of our invention will become apparent from a consideration of the drawings and ensuing description of the invention.

It is another object of the present invention to provide embodiments designed for simplicity of use, even elegance. The tool should be self evident as to its function. The tool should be easily cleanable.

It is yet another object of the present invention to reduce time in the coring process. A simple quick operation should render the food cored efficiently. Yet provide a cavity for a more complex or exotic dish.

### Embodiments of the Invention

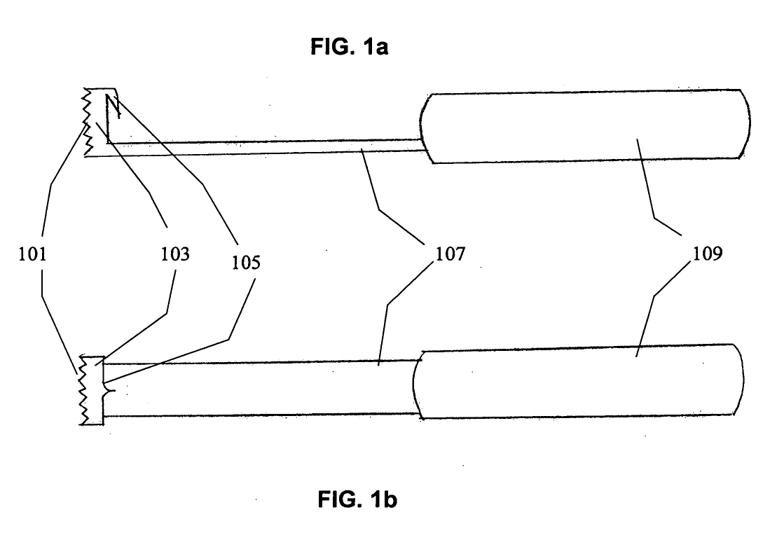

FIG. 1a and FIB. 1b are side view and top views respectively of the extracting corer in accordance with an embodiment of the invention.

The handle 109 is coupled to a thin stem 107. The stem 107 may be flat, with or without curvature, with or without cutting edges, or simply a sturdy rod construction. The stem may be coupled to the handle in a fixed configuration or a flexible pivotal coupling allowing the user to unsnap and rotate the handle 109 to provide the user with a corkscrew handle purchase. The stem 107 distal end is coupled to an annular ring element 103. The annular ring 103 serves several purposes. The ring 103 distal edge 101 is a cutting edge and may be sharpened in many ways. The annular ring 103 opposite or handle facing edge is coupled to a curved cutting surface core cutting and extract hook 105. The hook 105, ring 103 and stem 107 can be make from typical metal materials used in cutlery. The handle 109 can be composed of metal, plastic, composite, or most any rigid material which can sustain a torque required for cutting fruits, vegetables or other food items.

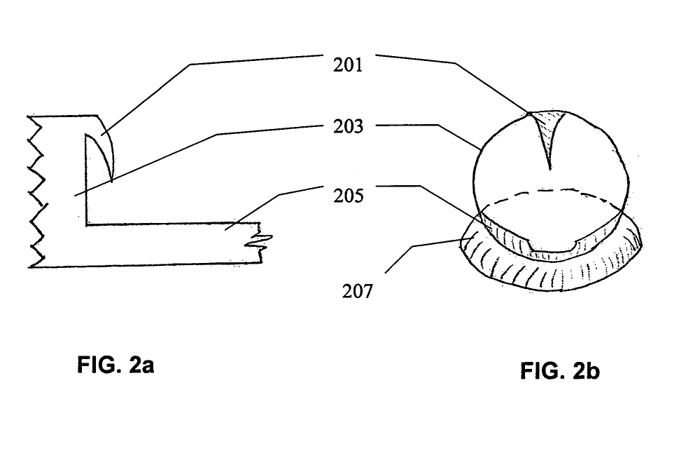

FIG. 2a and FIG. 2b are an expanded side view and an expanded front view of the distil end of the extracting corer respectively detailing the serrated edge and the core extract hook in accordance with an embodiment of the invention

The annular ring 203 is rigidly coupled to the stem 205 distal end. The rings 203 cutting edge 201 is shown serrated as it servers to cut through the interior of a food item. This can be done with a hand twisting back and forth with some forward force of the device. Once the ring 203 is to the desired depth, a complete hook rotation will sever the core, since the sharp triangular curved hook penetrates to the core axis center, and allow a smooth tear free extraction. The handle 207 is shown coupled rigidly to the stem 205 but this will vary on other embodiments, where the handle is coupled to unsnap from the stem and pivotably coupled such that the hand can be rotated and used perpendicular to the stem, as in the case of a bottle cork screw.

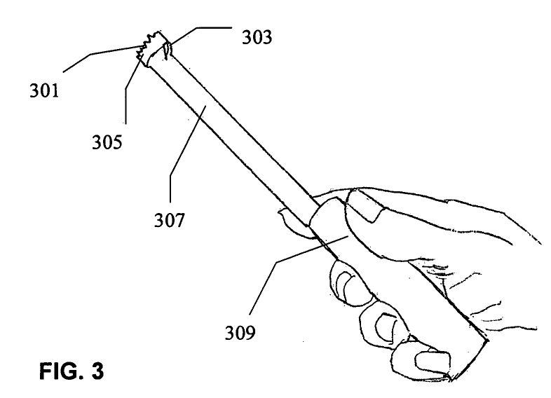

FIG. 3 is a perspective view an extracting corer in accordance with an embodiment of the invention

Not shown in this embodiment, the annular ring 305 can be adjustable having a curling ring with wrap stabilizers for varying rind 305 diameters. Thus a small vegetable or large fruit will have different diameter cores to extract, accommodating size with the same tool. Also, the stem 307 can be slidably adjustable withdrawing inside the handle for longer or short food insertion depth. Also not shown are the industrial food processing attachment for coring mass quantities of fruits and or vegetables.

Operation

The invention tool would be inserted, the serrated end of the corer first, into the food item while rotating the handle back and forth. Upon reaching the desired depth of the food item, the corer is rotated axially one complete circle, which severs the core from the food. The core extract hook of the corer first cuts and then attaches to the inside core, which is then withdrawn and core removed. Food ingredients can then be added to the cavity created.

Therefore, while the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. A single piece device for coring fruits, vegetables and food comprising:
a handle,
rigid stem coupling an annular cutting ring to the handle,
a serrated cutting edge on the distal end of the annular cutting ring, and
a curved cutting surface hook element coupled to the opposite end of the annular cutting ring, hook tip extending substantially toward the cent of the ring axis,
whereby the annular cutting ring cutting edge is inserted in the food object to be cored, to the depth desired and the axially rotated allowing the curved hook to circumscribe the inside food object end freeing the food core for hollowing.

2. A single piece device for coring as in claim 1 further comprising extracting the inside meat without a full penetration for producing a cavity for other food ingredients.

3. A single piece device for coring as in claim 1 further comprising annular ring element, stem element and handle made of material from the set of materials consisting of metal, plastics, composites, wood and combinations.

4. A single piece device for coring as in claim 1 further comprising an axial symmetry providing utility for use with either hand.

5. A single piece device for coring as in claim 1 further comprising a slidably adjustable ring stem for core depth placement selection.

6. A single piece device for coring as in claim 1 further comprising an adjustable ring diameter.

7. A single piece device for coring as in claim 1 further comprising a pivoting handle allowing coring penetration from a perpendicular handle grip.

8. A single piece device for coring as in claim 1 further comprising a machine attachable handle facility for industrial mass food processing.
